(19) United States
(12) Patent Application Publication
(10) Pub. No.: US 2024/0057630 A1
(43) Pub. Date: Feb. 22, 2024

(54) CHEESE-ANALOGUE COMPOSITION

(71) Applicant: AAK AB, Malmo (SE)

(72) Inventor: Mads Clausen PEDERSON, Malmo (SE)

(21) Appl. No.: 18/259,475

(22) PCT Filed: Jan. 28, 2022
(86) PCT No.: PCT/SE2022/050093

§ 371 Date: Jun. 27, 2023

(30) Foreign Application Priority Data
Jan. 29, 2021 (SE) 2130029-8

(51) Int. Cl. A23C 20/02; A23D 9/007; C11C 3/10

(52) U.S. Cl. CPC A23C 20/02; A23D 9/007; C11C 3/10

(57) ABSTRACT

A cheese analogue composition comprises from 20% to 30% by weight of a fat composition; from 1% to 45% by weight of a starch; from 0% to 15% by weight of non-animal protein; and from 35% to 65% by weight of water; wherein the combined weight percent of starch and non-animal protein in the composition does not exceed 45%; wherein the fat composition comprises from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition.

### FIELD OF THE INVENTION

The invention relates to cheese analogue compositions comprising a fat composition, starch, water, and optionally non-animal protein, and the use of said cheese analogue compositions in food products. In particular, the invention relates to the use of certain fat compositions in cheese analogue compositions to improve various properties of the cheese analogue compositions.

### BACKGROUND OF THE INVENTION

There is an increasing demand for plant-based foods due to consumers' increasing desire to eat healthy, sustainably sourced food products and to generally lower their meat and dairy intake. There is also an increasing number of vegans who require food products to be completely absent of animal-derived products for ethical and health reasons.

This has led to the development of various plant-based food products such as plant-based meats (meat analogue compositions) and plant-based cheeses (cheese analogue compositions) which aim to mimic certain qualities of the animal-derived meat and cheese products, such as the texture, taste and/or appearance.

The typical content of a cheese analogue composition is plant-based fat typically present in an amount of from 20% to 30% by weight of the composition, starch, non-animal protein and water, along with additives such as flavourings and colourings. Typically, the total amount of starch and non-animal protein present in the compositions remains constant between different cheese analogue compositions. Softer cheese analogue compositions such as spreads and soft cheeses will typically contain relatively more water and less starch and protein, with the opposite being the case for hard cheese analogues.

It has been found difficult in the art for plant-based cheeses to effectively mimic the sensory and functional properties of animal-derived dairy cheeses. This challenge is increased by the many different dairy cheeses in existence with different properties (such as hard cheeses; pizza cheese; brie-type cheeses; spreadable cheeses etc.) meaning that many different systems of plant-based cheese with different properties are desired to mimic the many corresponding types of dairy cheese. In dairy based cheeses, the properties of the cheese are determined by many factors. A key factor is the nature of the fat and proteins present in the cheese. Dairy cheese is produced from milk and contains animal milk-derived fats and animal-milk derived proteins such as casein which are key in providing the desired properties of the dairy cheeses. In dairy cheese making, coagulation of milk fats and proteins occurs to produce the cheese as a result of destabilisation of casein micelles present in the milk. It has been found challenging in the art to provide chemical systems derived entirely from non-animal sources that can provide compositions with all of the properties (and the ability to tailor said properties depending on cheese type) of dairy cheese. In particular, it has been found difficult to provide a non-animal derived fat suitable for use in cheese analogue compositions that is suitable for providing all of the desired properties for each of the many different types of cheese analogue composition.

Current solutions in the cheese analogue field involve using the nature of the fat and the relative amounts of fat, water and starch in the composition to provide and tailor the sensory and functional properties of the cheese analogue compositions. The vast majority of plant-based cheeses in existence use coconut oil as the source of fat. Coconut oil is plant derived and so fulfils the criteria for being suitable for use in vegan food products. Coconut oil also has a higher melting point than many other vegetable derived oils (such as sunflower oil) and so is better than these other vegetable oils at mimicking the properties of animal-derived fats. Animal derived fats typically have higher melting points than vegetable oils. Coconut oil is also preferable over other higher melting point vegetable oils such as palm oil due to the negative environmental effects associated with the production of palm oil. Furthermore, palm oil contains a high amount of palmitic acid residues which is considered to be detrimental to cholesterol levels of consumers. Consequently, the use of coconut oil in cheese analogue compositions as the fat is the current state of the art.

The inventors of the present invention have appreciated that there are certain negative effects and disadvantages resulting from the use of coconut oil in cheese analogue compositions. Firstly, coconut oil is high in saturated fatty acid residues which is undesirable for consumers from a health perspective due to the association of saturated fatty acid residues in fats with heart disease, undesirable cholesterol levels, and related conditions.

Additionally, the inventors of the present invention have appreciated that where coconut oil is used in cheese analogue compositions to contribute to the provision of various desired properties of the cheese analogue, these desired properties often fade over time after manufacture of the cheese, meaning that by the time the cheese is consumed by the consumer, the cheese often does not have the intended sensory and textural properties. Without being limited by theory, this is believed by the inventors to be partly attributed to the melting behaviour of coconut oil such as its very steep melting curve. The desired sensory and textural properties of the cheese analogues containing coconut oil that have been found by the inventors to decrease in desirability over time (such as during storage prior to consumption) include, but are not limited to, sensory properties like hardness, adhesiveness, cohesiveness, resilience and springiness; functional behavior like ability to slice, ability to handle sliced cheese, ability to handle shredded cheese, ability for the cheese to stretch when heated (for example in pizza applications), reduction of waste during slicing, reduction of waste during shredding, improved quality of sliced cheese and improved quality of shredded cheese.

It has been found by the inventors of the present invention that the use of certain fats in cheese analogue compositions instead of coconut oil and other fats can address and/or alleviate many of the problems discussed above associated with the use of coconut oil and other fats in such compositions.

The documents discussed below discuss the utility of certain fat compositions in certain food products. However, the use of the fat compositions in cheese analogue compositions, and the possible advantages associated therewith over the state of the art are not contemplated.

WO2019/185444 discloses non-hydrogenated fat compositions comprising from 3.2% to 10% by weight of total caprylic acid and capric acid; and from 13% to 32% by weight lauric acid; from 20% to 45% by weight stearic acid. The fat compositions contain from 7% to 15% by weight CN46 triglycerides; from 4% to 30% by weight CN54 triglycerides; and from 15% to 28% by weight of total CN42 and CN54 triglycerides. The fat compositions are disclosed for use in bakery and confectionary applications to improve the textural and sensory performance of baked goods and confections. In particular, the fat compositions are taught as being useful for inclusion in whipped cream compositions and beneficial for allowing air to be entrained therein.

EP2443935 discloses edible products comprising from 15% to 80% of a triglyceride composition; from 20% to 85% of at least one filler material and up to 15% water. The triglyceride compositions comprise from 20% to 70% by weight saturated fatty acid residues and up to 5% by weight of trans unsaturated fatty acid residues, and are high in lauric acid. The compositions are taught as being of high nutritional benefit compared to other high melting point vegetable derived fats due to the relatively low saturated fatty acid content and high lauric acid content. Fats with high lauric content are reported as being less likely to accumulate as body fat compared to fats containing a higher proportion of longer chain saturated fatty acids.

WO2016/162529 discloses triglyceride compositions having reduced saturated fatty acid contents and higher amounts of unsaturated fatty acids. The compositions are taught for use as oils for deep fat frying of food products. The oils are taught as having a better nutritional profile than conventional oils used in deep fat frying, and to provide crispiness and a lower risk of oil seeping out from deep fat fried food products. The deep fat fried products produced using the oil are also reported as having a less waxy mouth feel.

### SUMMARY OF THE INVENTION

The present invention is based upon the surprising finding that certain fat compositions solve or alleviate many of the problems discussed above associated with the use of coconut oil and other fats in cheese analogue compositions. It has been found that the certain fat compositions have an improved nutritional profile relative to coconut oil due to having lower amounts of saturated fatty acid residues. Additionally, surprisingly, the inclusion of these fat compositions in cheese analogue compositions in place of coconut oil has been found to not negatively affect, and in some cases improve various properties of cheese analogue compositions such as various sensory and functional properties of the compositions. Additionally, it has been found that the use of the certain fat compositions in cheese analogue compositions instead of coconut oil can reduce the extent to which a desired sensory or functional property reduces over time between manufacture of the cheese analogue composition and consumption. The use of the certain fat compositions has thus been found by the inventors to enable tailoring of the manufacture of the cheese such that the specific desired characteristics for a particular product are maintained fora longer period of time, meaning that said cheese compositions are more appealing to consumers. It has been found that one or more of the following properties can be improved, or the extent to which a desirable property reduces over time reduced for the following characteristics: sensory properties like hardness, adhesiveness, cohesiveness, resilience and springiness; functional behavior like ability to slice, ability to handle sliced cheese, ability to handle shredded cheese, ability for the cheese to stretch when heated (for example in pizza applications), reduction of waste during slicing, reduction of waste during shredding, improved quality of sliced cheese and improved quality of shredded cheese. In particular, it has been found that the hardness and firmness of the cheese analogue compositions can be reduced compared to compositions containing coconut oil, meaning that cheese analogues containing the certain fats are more acceptable to consumers. Too much hardness and firmness is less desirable from a taste and mouth feel perspective, and can also lead to a more brittle product causing the cheese to break up when shredded or chopped causing the formation of small particles known as “fines”. The certain compositions have also been found to reduce the extent to which hardness and firmness of the cheese analogues develop over time between manufacture and consumption. Cheese analogues containing coconut oil have been found by the inventors to undesirably increase in hardness and firmness after manufacture. The certain fat compositions have also been found to improve the sensory and taste properties of the cheese and its appearance in comparison to cheese analogues containing coconut oil.

Additionally, it has surprisingly been found by the inventors that the certain fat compositions are suitable for use in providing the desired properties of a variety of different types of cheese analogue compositions (for example all of hard cheese; soft cheese; spreadable cheese etc.). Some prior known fats are only suitable for use in some of these cheese analogue applications, but not all. As an additional advantage, if desired, the specific properties of the fat compositions, such as solid fat content, can be optimized for each of the different types of cheese analogue composition.

According to a first aspect of the invention, there is provided a cheese analogue composition comprising from 20% to 30% by weight of a fat composition; from 1% to 45% by weight of a starch; from 0% to 15% by weight of non-animal protein; and from 35% to 65% by weight of water; wherein the combined weight percent of starch and non-animal protein in the composition does not exceed 45%; wherein the fat composition comprises from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition.

Preferably, the fat composition comprises from 20% to 70% by weight of saturated fatty acids, and more preferably from 20% to 60% by weight of saturated fatty acids. In some embodiments, the fat composition comprises 65% to 85% by weight of saturated fatty acids. In other embodiments, the fat composition comprises from 20% to 65% by weight of saturated fatty acids. The amount of saturated fatty acid residues present in the fat composition may be tailored so as to provide the specific desired properties of the fat composition. For example, where the fat composition comprises a higher saturated fat content of from 65% to 85% by weight, the fat composition may be particularly useful for providing harder, brittle solid structures of fat. In other embodiments, the fat compositions comprise from 20% to 65% by weight of saturated fatty acids. Said fat compositions have been found useful in providing a more “plasticized” fat structure.

Notably, the fat compositions for use in compositions of the invention have a lower saturated fat content than coconut oil, meaning that said fat compositions improve the nutritional profile of compositions of the invention compared to those containing coconut oil. The saturated fat content of coconut oil is typically around 87%, whereas a typical saturated fat content of compositions for use in the invention is lower at around 61%. The saturated content of butter fat commonly present in dairy based cheeses is around 63%. Accordingly, fat compositions for use in the invention typically have lower saturated fat content than both fats present in dairy based cheeses and also cheese analogues containing coconut oil. In conventional dairy cheeses, the fat content is between 10% and 25%, meaning that the saturated fat content of said dairy cheeses is typically between 6% and 16%. In plant-based cheese analogue compositions, the fat content is typically higher at around 25% which would mean that cheese analogues containing coconut oil have a saturated fat content of around 22%. When using the certain fat compositions for use in the invention, the saturated fat content of the cheese analogue is typically around 15%. This means that the fat compositions for use in the invention can be used to reduce the saturated fat content of cheese analogues to be within the range typically found in conventional cheeses, compared to coconut oil cheese analogues that have a higher fat content.

Typically, the fat composition comprises from 2 to 12 percent by weight of St2M triglycerides, preferably from 5 to 12 percent by weight of St2M triglycerides. A St2M triglyceride is a triglyceride molecule comprising two stearic acid residues and one residue of either lauric acid or myristic acid. Without being limited by theory, it has been found that fat compositions comprising St2M triglycerides in the amounts specified above aids in providing both the plasticized fat structure effect and the solid brittle structure effect described above. The St2M triglycerides crystallise fast and bind oil well which aids in the provision of the effects discussed above.

Typically, the fat composition comprises from 5 to 35 percent by weight of CN46 and CN48 triglycerides, preferably from 10 to 30 percent by weight of CN46 and CN48 triglycerides. The abbreviation CN stands for the total carbon number of the fatty acid moieties present in the triglyceride molecule. For example, a triglyceride comprising two stearic acid residues and one lauric acid residue would have a total carbon number of 48.

Preferably, the fat composition comprises less than 10% by weight of palm oil, more preferably less than 5% by weight of palm oil, and still more preferably less than 2% by weight of palm oil. Most preferably the composition does not comprise palm oil.

The fat composition preferably is a non-hydrogenated fat composition.

The fat composition preferably comprises a greater amount of stearic acid than palmitic acid. This is advantageous from a nutritional perspective since stearic acid has a neutral effect upon total cholesterol and LDL cholesterol levels, whereas palmitic acid is known to increase total cholesterol and LDL cholesterol levels. Typically, the fat composition comprises 20% by weight or less, and preferably 10% by weight or less of palmitic acid (C16:0). Typically, the fat composition has a weight ratio of stearic acid (C18:0) to palmitic acid (C16:0) of from 1:1 to 12:1. Typically, the fat composition has a weight ratio of lauric acid (C12:0) to stearic acid (C18:0) of from 1:4 to 4:1. Preferably, the fat composition comprises from 10% to 25% by weight lauric acid (C12:0); and/or from 15% to 45% by weight stearic acid (C18:0). More preferably, the fat composition comprises from 10% to 25% by weight lauric acid (C12:0); and from 15% to 45% by weight stearic acid (C18:0).

Typically, the fat composition has a solid fat content (SFC) N35 of less than 5, measured on unstabilised fat according to ISO 8292-1, preferably 4 or less; more preferably 3 or less; and most preferably 2 or less.

In particular, it has been found that an N35 value of less than 5 is highly preferable for cheese analogue compositions. 35° C. is around mouth temperature. If the solid fat content of the fat composition is higher than around 5% at this temperature, the cheese analogue compositions do not have the desirable mouth feel associated with cheese and have a more waxy and dry flavour. A solid fat content of less than 5% at this temperature is believed by the inventors to be important for ensuring that the cheese analogue composition has similar sensory properties to cheese when eaten by the consumer.

Typically, the fat composition has a solid fat content (SFC) N10 of less than 60, measured on unstabilised fat according to ISO 8292-1. In some embodiments, the fat composition has a solid fat content (SFC) N10 of from 50 to 60, measured on unstabilised fat according to ISO 8292-1. The term “fat” as used herein refers to glyceride fats and oils containing fatty acid acyl groups and does not imply any particular melting point. The term “oil” is used synonymously with “fat” herein.

The term “fatty acid”, as used herein, refers to straight chain saturated or unsaturated (including mono- and poly unsaturated) carboxylic acids having 8 to 24 carbon atoms. A fatty acid having x carbon atoms and y double bonds may be denoted Cx:y. For example, palmitic acid may denoted C16:0, oleic acid may denoted C18:1. Percentages of fatty acids in compositions referred to herein include acyl groups in tri-, di- and mono-glycerides present in the glycerides and are based on the total weight of C8 to C24 fatty acids. The fatty acid profile (i.e. composition) may be determined, for example, by fatty acid methyl ester analysis (FAME) using gas chromatography according to ISO 12966-2 and ISO 12966.4.

Triglyceride content may determined for example based on molecular weight differences (Carbon Number (CN)) by AOCS Ce 5-86. The notation triglyceride CNxx denotes triglycerides having xx carbon atoms in the fatty acyl groups, e.g. CN54 includes tristearin. Amounts of triglycerides specified with each carbon number (CN) as is customary terminology in the art are percentages by weight based on total triglycerides of CN26 to CN62 present in the fat composition.

The fat composition may be made from naturally occurring or synthetic fats, fractions of naturally occurring or synthetic fats, or mixtures thereof, that satisfy the requirements for fatty acids and triglyceride compositions discussed above. Preferably, the fat composition is derived from a blend of naturally occurring fats.

Preferably, the fat composition comprises an interesterified fat, and more preferably wherein the fat composition comprises an interesterified fat blend. The interesterified fat or interesterified fat blend may be produced by chemical interesterification, enzymatic interesterification, or a combination thereof.

In some embodiments, the interesterified fat or interesterified fat blend is produced by an enzymatic interesterification reaction which does not reach an equilibrium product distribution. It has been found that these embodiments provide a fat composition product with optimum properties for use in a cheese analogue composition, such as the properties discussed above.

Processes for the preparation of the fat compositions such as the interesterification reactions discussed above are known in the art, and are discussed in, for example, Dijkstra, A. J. Interesterification. In: The Lipids Handbook 3^{rd} Edition, pages 285-300 (F. D. Gunstone, J. L. Harwood, and A. J. Dijkstra (eds.), Taylor & Francis Group LLC, Boca Raton, FL) (2007).

Preferably, the fat composition comprises an interesterified fat blend comprising a vegetable oil high in stearic acid and a vegetable oil high in lauric acid. Preferably, the vegetable oil high in stearic acid is also high in monounsaturated fatty acids such as oleic acids. Accordingly, in typical embodiments, the fat composition comprises an interesterified fat blend comprising at least one fat selected from shea butter, shea stearin, shea olein, cocoa butter, cocoa stearin, cocoa olein, allanblackia fat, kokum fat, mango kernel fat, sal fat, illipe butter, and mixtures thereof; and at least one oil selected from coconut oil, coconut oil stearin, coconut oil olein, palm kernel oil, palm kernel olein, palm kernel stearin, babassu oil, and mixtures thereof.

In preferable embodiments, the fat composition comprises an interesterified blend of shea butter and coconut oil or an interesterified blend of shea stearin and coconut oil. For example, in some embodiments, the fat composition comprises an interesterified blend of from 20% to 80% by weight of shea butter and from 20% to 80% by weight of coconut oil. In other embodiments, the fat composition comprises an interesterified blend of from 20% to 80% by weight of shea stearin and from 20% to 80% by weight of coconut oil.

In highly preferable embodiments, the fat composition comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of sunflower oil.

Preferably, the fat composition contains a substantially major portion of fat with very little water (i.e. the fat composition consists essentially of fat molecules). However, in some embodiments, the fat composition may contain water and be present in the form of an emulsion such as an oil-in-water emulsion or a water-in-oil emulsion, typically with a suitable emulsifier. In such embodiments, the weight percentage ranges provided above for the amount that the fat composition is present in the cheese analogue composition refers to only fat molecules present in the fat composition, and not any water present in the composition. Similarly, the weight percentages given above for the amount of water present in the cheese analogue composition refers to both water added in its own right during manufacture of the cheese analogue composition, and also to any water present in other components of the cheese analogue composition (such as water present in an emulsified fat composition), or water bound to any protein, as discussed in further detail below.

The cheese analogue compositions of the invention may comprise one or more non-animal proteins, such as one or more proteins derived from fungi, plants, or a combination thereof.

Typically, the non-animal protein comprises plant protein. Preferably, the plant protein is selected from algae protein, black bean protein, canola wheat protein, chickpea protein, fava protein, lentil protein, lupin bean protein, mung bean protein, oat protein, pea protein, potato protein, rice protein, soy protein, sunflower seed protein, wheat protein, white bean protein, and protein isolates or concentrates thereof. In other embodiments, the non-animal protein comprises seitan, rice protein, mushroom protein, legume protein, tempeh, yam flour, tofu, mycoprotein, peanut flour, yuba, nuts, protein derived from nuts, nut derived milk products, or a combination thereof.

Plant protein is a source of protein which is obtained or derived from plants. The plant protein may be any suitable plant protein and may comprise a mixture of plant proteins and/or may include protein isolates or concentrates. Examples of suitable plant proteins include those discussed above.

As discussed above, the weight percentage ranges referred to above for water present in the cheese analogue compositions include both water added in its own right and water present in other components of the cheese analogue composition such as in vegetable proteins or emulsified with fat. Similarly, the weight percentage ranges given below for the amount of non-animal protein present in the cheese analogue composition refer to dry weight of protein, and do not include water bound to the non-animal protein.

The plant protein used in the preparation of the cheese analogue composition may be either dry (also ref erred to as ‘dry phase’ herein) or moist. Thus, in embodiments, the plant protein may be included in a dry mix of ingredients, which may include additional ingredients intended for inclusion in the cheese analogue composition, such as carbohydrates, fibre and/or hydrocolloids, in addition to protein. If the plant protein is dry, it may be hydrated prior to and/or during the formation of the cheese analogue composition. The term ‘dry’ used in relation to the plant protein and ‘dry phase’ used herein, is intended to mean that the phase comprising plant protein comprises less than 5 wt. % water, preferably less than 2 wt. % water, more preferably less than 1 wt. % water, even more preferably that it is substantially free from water. In other preferred embodiments, the aw of the dry phase is 0.90 or lower, more preferably below 0.80. The dry phase comprising plant protein is typically provided in a substantially dehydrated state to reduce microbial growth as far as possible so as to extend shelf life.

If present in the cheese analogue compositions, the non-animal proteins are typically present in the cheese analogue compositions in an amount of up to 15% by weight of the cheese analogue composition. Preferably, the non-animal protein is present in an amount of 12.5% or less by weight of the cheese analogue composition, such as 10% by weight or less of the cheese analogue composition.

Cheese analogue compositions of the invention comprise one or more starches. The starches may comprise any suitable type of starch such as those starches known in the art for inclusion in cheese analogue compositions. Examples of starches that can be included include non-modified starches, modified starches, or a combination thereof. In some embodiments, the starch comprises non-modified or modified vegetable starch, rice starch, tapioca starch, or a combination thereof. In one embodiment, the starch comprises modified starch derived from potatoes. Preferably, the starch comprises potato starch, waxy maize starch, tapioca starch, or a combination thereof.

Specific examples of starches and modified starches that can be included in the cheese analogue compositions include a mixture of oxidised starch E1404 and starch sodium octenyl succinate E1450 where the modified starches are derived from potato starch; SIMPLISTICA™ VCP 1214 OG which comprises starch derived from potato, maize and tapioca; KaTech NDG 1098.72 which comprises potato starch and carrageenan; Perfectasol TM D500 which comprises enzymatically modified potato starch and potato protein, modified waxy maize starch (E1450); and Perfectasol TM D510 which comprises acid treated potato starch, hydroxypropylated distarch phosphate of potato origin, and pregelatinized starch sodium octenyl succinate of potato origin.

Without being limited by theory, it is believed that the starch is important for contributing to the various sensory and functional properties of the cheese analogues such as how hard or soft the cheese is, as discussed in further detail below, and also various functional properties of the cheese such as its stretchability on heating (an important function in the case of pizza cheese), and sliceabillity.

The starches are believed to help aid in providing the effects provided by casein in dairy cheeses, such as providing the requisite properties for various different applications.

The starches are present in the cheese analogue composition in an amount of from 1% to 45% by weight of the cheese analogue composition, such as 5% to 45% by weight. Typically, the starch is present in an amount of from 20% to 30% by weight of the cheese analogue composition.

As discussed above, if the cheese analogue compositions contain protein, the protein is typically present in the compositions in amount of up to 15% by weight of the cheese analogue compositions.

Typically, the combined weight percent of starch and non-animal protein in the cheese analogue compositions does not exceed 45%. Preferably, the combined weight percent of starch and non-animal protein in the cheese analogue composition is less than 35% and preferably from 20% to 30%. In these embodiments, the non-animal protein is typically present in an amount of less than 12.5% by weight of the cheese analogue composition such as from 5% to 12.5%, or from 5% to 10% by weight of the cheese analogue composition, although it will be appreciated that even less protein may be present, or in some embodiments protein may be completely omitted from the compositions.

In this respect, when protein is included in the cheese analogue compositions, the protein included is used as a replacement for starch, since the combined amount of protein and starch does not exceed the limits discussed above. The protein may also carry out the same role as starch discussed above in the cheese analogue compositions.

The cheese-analogue composition comprises water, which may be added as a separate component to the composition, or derive from other components of the composition as discussed above. The amount of water is not particularly limited and, as the skilled person will appreciate, will vary depending on the intended consistency of the cheese-analogue composition, as discussed in further detail below. Reference to ‘water’ herein is intended to include drinking water, demineralized water or distilled water, unless specifically indicated. Preferably, the water employed in connection with the present invention is demineralised or distilled water. As the skilled person will appreciate, deionized water is also a sub-class of demineralized water. In some embodiments, water may be added to the composition where the water is a condensate from steam used to heat the various components or combination of components of the cheese analogue composition during manufacture.

The cheese analogue composition typically comprises one or more additional ingredients. Whilst these one or more additional ingredients may be preferable to include in the cheese analogue compositions, it will be understood that the inclusion of the one or more additional ingredients is not essential.

Preferably, the cheese analogue composition comprises one or more flavouring additives, preferably wherein the one or more flavouring additives are present in an amount of from 0.1% to 5% by weight of the cheese analogue composition.

Preferably, the cheese analogue composition comprises one or more colouring additives, preferably wherein the one or more colouring additives are present in an amount of from 0.01% to 1% by weight of the cheese analogue composition.

In some embodiments, the cheese analogue composition further comprises one or more of: i) polysaccharides and/or modified polysaccharides, preferably selected from methylcellulose, hydroxypropyl methylcellulose, carboxymethyl cellulose, maltodextrin, carrageenan and salts thereof, alginic acid and salts thereof, agar, agarose, agaropectin, pectin and alginate; ii) hydrocolloids; and iii) gums, preferably selected from xanthan gum, guar gum, locust bean gum, gellan gum, gum arabic, vegetable gum, tara gum, tragacanth gum, konjac gum, fenugreek gum, and gum karaya.

Examples of other additives that may be included in the cheese analogue compositions include an ionic or non-ionic emulsifier, a polyhydroxy compound, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, salt, spices, fibre, thickening and gelling agents, egg powder, enzymes, gluten, vitamins, preservatives, sweeteners, oxidising agents, reducing agents, anti-oxidants, acidity regulators, or combinations thereof.

In preferable embodiments, the cheese analogue is suitable for consumption by vegetarians and vegans. Accordingly, in preferable embodiments, the cheese analogue composition is substantially free of animal protein, and more preferably, the cheese analogue composition is free of animal protein.

In preferable embodiments, the cheese analogue composition is substantially free of animal-derived products, and more preferably, the cheese analogue composition is free of animal-derived products.

However, in some embodiments, the cheese analogue compositions may comprise animal-derived products such as animal derived proteins or fats. Accordingly, in some embodiments, the cheese analogue composition further comprises one or more animal-derived products such as animal oils, marine oils, animal-derived proteins, animal-derived polysaccharides, or any combination thereof. In some embodiments, the one or more animal-derived products comprise animal milk proteins, animal milk fats, or a combination thereof. In these embodiments, the cheese analogue compositions may be suitable for consumption by vegetarians on the basis that they comprise non-animal protein and proteins or fats derived from animal milk. These cheese analogue compositions are suitable for consumption by vegetarians since they do not include fats or proteins derived from animals. However, it will of course be understood that such cheese analogue compositions are not suitable for consumption by vegans.

In embodiments where the cheese analogue compositions comprise one or more animal-derived products, the one or more animal-derived products are typically present in the cheese analogue composition in an amount of from 0.1% to 20% by weight of the cheese analogue composition.

The specific properties of the cheese analogue compositions may be tailored by tailoring the relative amounts of the fat composition, water, starch, and protein (if present), in the compositions. The properties of the cheese analogue composition may be tailored and optimised so as to provide different types of cheese analogue compositions. For example, there are many types of cheese analogue compositions in existence with very different properties. As will be appreciated by the skilled person, different properties are desirable for different applications. For example, a spreadable cheese (such as a cream cheese analogue) will desirably be soft and spreadable and have very different properties than for example a parmesan cheese analogue which will desirably be hard but grateable into small particles, or sandwich cheese which must be more resilient but easily sliceable. Other properties that the cheese analogue may be desirable to have include stretchiness at elevated temperature such as mozzarella pizza cheese analogues.

When optimising and tailoring the physical properties of a particular cheese analogue, typically, the weight percentage of the fat composition in the cheese analogue composition will remain similar between the different types of cheese analogue. For example, both cream cheese and hard cheese would typically contain similar amounts of the fat composition, such as in an amount of from 20% to 30% by weight of the cheese analogue composition. In contrast, the water content of the cheese analogue compositions and the combined protein and starch content of the compositions are typically varied and optimised for providing different sorts of cheese compositions. Typically, for harder cheese analogue compositions, the compositions contain a relatively lower water content and a relatively higher combined protein and starch content. The opposite is the case for softer cheese. Spreadable cheeses such as cream cheese analogues will have the highest water content and lowest relative combined starch and protein content.

In some embodiments, the cheese analogue composition comprises from 35% to 55% by weight of water; and wherein the combined weight percent of starch and non-animal protein in the cheese analogue composition is from 25% to 35%. Typically, the fat composition will be present in an amount of from 20% to 30% by weight of the composition. Typically, such cheeses will have the desired properties of harder cheeses and the cheese analogue compositions will be compositions such as a cheddar cheese, parmesan cheese, f eta cheese, sandwich cheese, or similar-type cheese analogue compositions.

In other embodiments, the cheese analogue composition comprises from 45% to 55% by weight of water; and wherein the combined weight percent of starch and non-animal protein in the cheese analogue composition is from 20% to 35%. Typically, the fat composition will be present in an amount of from 20% to 30% by weight of the composition. Typically, such cheeses will have the desired properties of softer cheeses and the cheese analogue composition will be a brie or brie-type cheese, pizza cheese, or similar-type cheese analogue composition.

In other embodiments, the cheese analogue composition comprises from 50% to 65% by weight of water; and wherein the combined weight percent of starch and non-animal protein in the cheese analogue composition is from 5% to 25%. Typically, the fat composition will be present in an amount of from 20% to 30% by weight of the composition. Typically, such cheeses will have the desired properties of spreadable cheeses such as cream cheeses and the like, and the cheese analogue compositions will be spreadable cheese analogue compositions.

As discussed above, surprisingly, it has been found that the fat compositions described herein are suitable for use in all of the different types of cheese analogue composition discussed above, and can provide the desired properties of each type of cheese analogue. This is in contrast to certain fats known in the art for use in cheese analogue compositions that can provide the desired properties for some types of cheese analogue compositions, but not others.

According to a second aspect of the invention, there is provided a food product comprising a cheese analogue composition according to the first aspect of the invention.

Preferably, the food product is a vegetarian or vegan food substitute product.

The food product can be any cheese analogue composition food product, or food product comprising the cheese analogue compositions of the invention. The cheese analogue compositions of the invention can be provided as any type of cheese analogue composition food product. Preferably, the food product comprises a pizza cheese, a sandwich cheese, a feta cheese, a soft spreadable cheese, or a hard cheese; more preferably wherein the food product comprises a pizza cheese, a sandwich cheese, or a feta cheese.

The properties of the cheese-analogue composition or food products prepared using the composition may be measured by any suitable means. Properties of interest may include hardness, adhesiveness, springiness, cohesiveness, and resilience. Such means include taste testers, which can provide feedback on properties of the composition or food product such as juiciness (or dryness), texture, chewiness and hardness. Typically multiple testers will be asked to mark one or more properties of the composition or food product, such as on a scale from 1 to 5. If multiple testers are asked, an average of the results can be taken to observe the general impression of the food product.

Properties of the composition or food product may also be measured using specialised equipment. For example, texture profile analysis (TPA) is a technique used to characterize textural attributes of solid and semisolid materials and may be used to determine the hardness, adhesiveness, springiness, cohesiveness, gumminess, chewiness and resilience. In this technique, the test material may be compressed two times in a reciprocating motion, mimicking the chewing movement in the mouth, producing a Force versus Time (and/or distance) graph, from which the above information can be obtained. TPA and the classification of textural characteristics is described further in Bourne M. C., Food Technol., 1978, 32 (7), 62-66 and Trinh T. and Glasgow S., ‘On the texture profile analysis test’, Conference Paper, Conference: Chemeca 2012, Wellington, New Zealand, and may be performed as described therein.

The Force versus Time (and/or distance) graph typically includes two peaks in force, corresponding to the two compressions, separated by a trough. Force may be measured in gravitational force equivalent (g-force, g) or Newtons (N).

Hardness (g or N) is defined as the maximum peak force experienced during the first compression cycle.

Adhesiveness is defined as the negative force area for the first bite, i.e. the area of the graph between the two peaks in force which is at or below a force of 0 g or N. This represents the work required to overcome the attractive forces between the surface of a food and the surface of other materials with which the food comes into contact, i.e. the total force necessary to pull the compression plunger away from the sample. For materials with a high adhesiveness and low cohesiveness, when tested, part of the sample is likely to adhere to the probe on the upward stroke. Lifting of the sample from the base of the testing platform should, if possible, be avoided as the weight of the sample on the probe would become part of the adhesiveness value. In certain cases, gluing of the sample to the base of a disposable platform has been advised but is not applicable for all samples.

Springiness, also known as elasticity, is related to the height that the food recovers during the time that elapses between the end of a first compression and the start of a second compression. During the first compression, the time from the beginning of the compression at force=0 g or N to the first peak in force is measured (referred to as ‘Cycle 1 Duration’). During the second cycle, the time from the beginning of the second compression at force=0 g or N to the second peak in force is measured (referred to as ‘Cycle 2 Duration’). Springiness is calculated as the ratio of these values, i.e. ‘Cycle 2 Duration’/‘Cycle 1 Duration’.

Cohesiveness is defined as the ratio of the positive force area, i.e. the area under the curve above a force of 0 g or N, during the second compression to that during the first compression. Cohesiveness may be measured as the rate at which the material disintegrates under mechanical action. Tensile strength is a manifestation of cohesiveness. If adhesiveness is low compared with cohesiveness then the probe is likely to remain clean as the product has the ability to hold together. Cohesiveness is usually tested in terms of the secondary parameters brittleness, chewiness and gumminess.

Resilience is a measurement of how the sample recovers from deformation both in terms of speed and forces derived. It is taken as the ratio of areas from the first probe reversal point, i.e. the point of maximum force, to the crossing of the x-axis, i.e. at 0 g or N, and the area produced from the first compression cycle between the start of compression and the point of maximum force. In order to obtain a meaningful value of this parameter, a relatively slow test speed should be selected that allows the sample to recover, if the sample possesses this property.

According to a third aspect of the invention, there is provided the use of a fat composition in a cheese analogue composition, wherein the fat composition comprises from 20% to 80% by weight of saturated fatty acids; from 10% to 50% by weight of stearic acid (C18:0); and from 2% to 35% by weight of lauric acid (C12:0); wherein said percentages of fatty acid residues refers to fatty acids bound as acyl groups in glycerides in the fat composition and being based on the total weight of C4 to C24 fatty acid residues bound as acyl groups present in the fat composition; and wherein the cheese analogue composition comprises from 20% to 30% by weight of the fat composition; from 1% to 45% by weight of a starch; from 0% to 15% by weight of non-animal protein; and from 35% to 65% by weight of water; wherein the combined weight percent of starch and non-animal protein in the composition does not exceed 45%.

Preferably, the use further comprises using the cheese analogue composition in a food product, such as those discussed above.

Preferably, the cheese analogue composition, fat composition, and/or food product are as discussed above in accordance with the first and second aspects of the invention.

Preferably, the use comprises using the fat composition to improve the nutritional profile of the cheese analogue composition when compared to an analogous cheese analogue composition comprising the same amount by weight of coconut oil.

Preferably, the use comprises using the fat composition to improve the effect of in vivo cholesterol levels in a consumer of the cheese analogue composition when compared to an analogous cheese analogue composition comprising the same amount by weight of coconut oil.

The term analogous cheese analogue composition as used herein is used to refer to an equivalent weight of a cheese analogue composition that is identical to the cheese analogue composition of the invention, with the exception of the nature of the fat present therein. The analogous cheese analogue composition contains the same amount by weight of coconut oil as the cheese analogue composition of the invention contains the fat composition. The nutritional profile of the cheese analogue composition of the invention may be improved in comparison to coconut oil since it contains a lower total amount of saturated fatty acid residues per unit weight than coconut oil. Coconut oil contains around 90% saturated fatty acid residues. Without being limited by theory, it is believed that fats with higher saturated fatty acid contents increase the risk of heart disease, high blood pressure and associated conditions, and also have a detrimental effect upon the cholesterol levels of consumers. Accordingly, in some embodiments, the use comprises using the fat composition to improve the effect on in vivo cholesterol levels in a consumer of the cheese analogue composition when compared to an analogous cheese analogue composition comprising the same amount by weight of coconut oil, although it will be appreciated that other health and wellbeing benefits may also be realised by the use of the fat compositions in cheese analogue compositions in place of coconut oil and similar fats.

The use may comprise using the fat composition to provide delayed release of flavours from the cheese analogue composition when consumed when compared to an analogous cheese analogue composition comprising the same amount by weight of coconut oil. Without being limited by theory, the delayed release of flavours compared to coconut oil is believed to be due to the fat compositions having a higher solid fat content than coconut oil at mouth temperatures of from 30° C. to 35° C. Many flavour and flavouring additive compounds are fat soluble and so are dissolved within the fat of the cheese analogue composition. With a higher solid fat content, the release of the dissolved flavours from the fat is delayed over a longer period of time. The delayed release of flavours is believed to enable the cheese analogue composition to more closely resemble the mouth feel and delayed flavour release of cheese, which contains higher melting point fats which typically have higher solid fat contents at mouth temperature.

Typically, the use comprises using the fat composition to improve one or more sensory properties and/or one or more functional properties of the cheese analogue composition when compared to an analogous cheese analogue composition comprising the same amount by weight of coconut oil. Examples of such properties include sensory properties like hardness, adhesiveness, cohesiveness, resilience and springiness; functional behavior like ability to slice, ability to handle sliced cheese, ability to handle shredded cheese, ability for the cheese to stretch when heated (for example in pizza applications), reduction of waste during slicing, reduction of waste during shredding, improved quality of sliced cheese and improved quality of shredded cheese; or any combination of these properties.

Preferably, the one or more sensory properties comprise hardness, adhesiveness, cohesiveness, resilience, springiness, or a combination thereof.

Preferably, the one or more functional properties comprise ability to slice, ability to handle, ability to stretch when heated, reduction in waste during slicing, reduction of waste during shredding, improved quality of the cheese, or a combination thereof.

In a highly preferred embodiment, the use comprises using the fat composition to reduce the hardness of the cheese analogue composition when compared to an analogous cheese analogue composition comprising the same amount by weight of coconut oil. In such embodiments, preferably, the use comprises using the cheese analogue composition in a pizza cheese food product, a sandwich cheese food product, or a feta cheese food product.

In another highly preferred embodiment, the use comprises using the fat composition to reduce the extent to which the cheese analogue composition increases in hardness over time compared to an analogous cheese analogue composition comprising the same amount by weight of coconut oil. Preferably, in these embodiments, the use comprises using the cheese analogue composition in a pizza cheese food product, a sandwich cheese food product, or a feta cheese food product.

Without being limited by theory, it is believed that the steep melting curve of coconut oil is partly responsible for the reduction in the desired properties of the cheese analogue composition over time between manufacture and consumption. Coconut oil is a brittle solid at temperatures below 15° C., whereas at temperatures of around 30° C. to 35° C., the coconut oil contains very little solid fat. This steep melting curve has been found to contribute to reducing the desirable properties of cheese analogue compositions comprising coconut oil over time.

In an embodiment, the use comprises using the fat composition in a cheese analogue composition, and wherein the use comprises using the fat composition to reduce the brittleness and/or firmness of the cheese analogue composition compared to an analogous cheese analogue composition comprising the same amount by weight of coconut oil, preferably, wherein the use comprises using the fat composition in a pizza cheese food product or a sandwich cheese food product.

In another embodiment, the use comprises using the fat composition in a cheese analogue composition and wherein the use comprises using the cheese analogue composition in a pizza cheese food product or a sandwich cheese food product, and wherein the use comprises using the fat composition to improve the appearance of the food product compared to an analogous food product comprising a cheese analogue composition comprising the same amount by weight of coconut oil.

According to a fourth aspect of the invention, there is provided a process of manufacturing a cheese analogue composition according to the first aspect of the invention, or a food product according to the second aspect of the invention, wherein the process comprises combining a fat composition as discussed above in accordance with the first aspect of the invention, water, starch, and optionally non-animal protein and/or one or more additional components to the form the cheese analogue composition, and optionally forming the cheese analogue composition into food products.

The process of the invention may comprise any suitable process known in the art for forming cheese analogue compositions and food products comprising said compositions.

In some embodiments, the process comprises combining the ingredients at a temperature of from 70° C. to 85° C., and preferably from 75° C. to 80° C. At such temperatures, the fat compositions will melt and be able to be mixed intimately and uniformly with the water, starch and protein and other components if present so as to form a uniform system. The components can be mixed with each other in any suitable order, as will be appreciated by those skilled in the art.

On combining, the ingredients of the composition are typically mixed with a shear mixer. Typically, a higher shear is used to mix the ingredients when the cheese analogue composition is a softer composition such as a cream cheese or other spreadable cheese analogue composition. A relatively lower shear is typically used for harder cheese analogue compositions.

Whilst the above described steps are preferable steps for manufacturing the cheese analogue compositions or food products described herein, it will be appreciated that other suitable processes may also be used to manufacture the cheese analogue compositions and food products.

### DESCRIPTION OF THE DRAWINGS

FIG. 1 shows a graph of the hardness and hardness change over time for a cheese analogue according to the invention and a comparative cheese analogue comprising coconut oil.

FIG. 2 shows the sensory profile of a cheese analogue according to the invention and a comparative cheese analogue comprising coconut oil.

FIG. 3 shows a graph of the hardness and hardness change over time for a cheese analogue according to the invention and a comparative cheese analogue comprising coconut oil.

FIG. 4 shows the sensory profile of a cheese analogue according to the invention and a comparative cheese analogue comprising coconut oil.

FIG. 5 shows a graph of the hardness and hardness change over time for a cheese analogue according to the invention and a comparative cheese analogue comprising coconut oil.

FIG. 6 shows the sensory profile of a cheese analogue according to the invention and a comparative cheese analogue comprising coconut oil.

### DETAILED DESCRIPTION OF THE INVENTION

The following examples are for illustrative purposes only, and are not intended to limit the scope of the invention in any way.

### EXAMPLE 1

A pizza cheese analogue composition according to the invention was manufactured. The cheese analogue composition comprised 46% by weight water; 27% by weight of a starch and non-animal protein blend; 25% by weight of a fat composition as described herein and 2% by weight salt. The fat composition was an interesterified blend of 70 wt % shea butter and 30 wt % coconut oil.

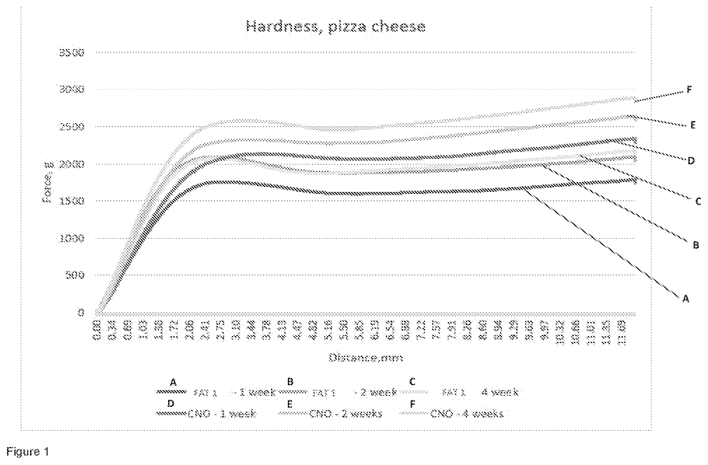

The hardness of the pizza cheese and its change in hardness over time were measured. The results were compared against a comparative cheese comprising coconut oil and are shown in FIG. 1. The compositions of the invention are indicated by the abbreviation Fat 1 and the coconut oil comparative compositions by the abbreviation CNO. The comparative cheese analogue composition was the same as the composition of the invention except that it comprised 25% by weight coconut oil instead of 25% by weight of the interesterified fat blend composition.

It can be seen that the softest cheese was the cheese of the invention after 1 week. After 2 and 4 weeks, the hardness of this cheese increased. Even after 4 weeks, the cheese of the invention is still softer than the comparative cheese comprising coconut oil. The comparative cheese comprising coconut oil also increased in hardness after 2 weeks and 4 weeks. It can be seen that the increase in hardness after 2 weeks and 4 weeks is less for the cheese of the invention compared to the cheese containing coconut oil.

The data in FIG. 1 thus shows that the cheese of the invention has associated therewith the desirable characteristic of being less hard, and also the desirable characteristic of a lower increase in hardness over time, when compared to the comparative cheese containing coconut oil. These characteristics are more attractive to the user and result in an improved sensory experience upon consuming the cheese.

The coconut oil comparative cheese has a harder, more brittle, and crisp texture which causes the cheese to break up when shredded and produce more fines (crumbles). These fines are less attractive from a commercial point of view.

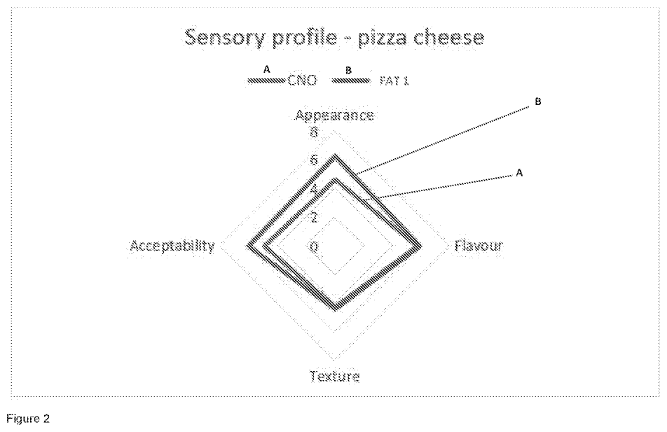

The pizza cheese and the comparative pizza cheese containing coconut oil were subjected to a sensory evaluation. The results of this evaluation are shown in FIG. 2. It can be seen that the cheese of the invention scores more highly on appearance and acceptability to the sensory testers than the comparative cheese containing coconut oil.

### EXAMPLE 2

A sandwich cheese analogue composition according to the invention was manufactured. The cheese analogue composition comprised 49% by weight water; 24% by weight of a starch blend; 25% by weight of a fat composition as described herein; 1% by weight salt; and 1% by weight of the additive carrageenan K100. The fat composition was an interesterified blend of 70 wt % shea butter and 30 wt % coconut oil.

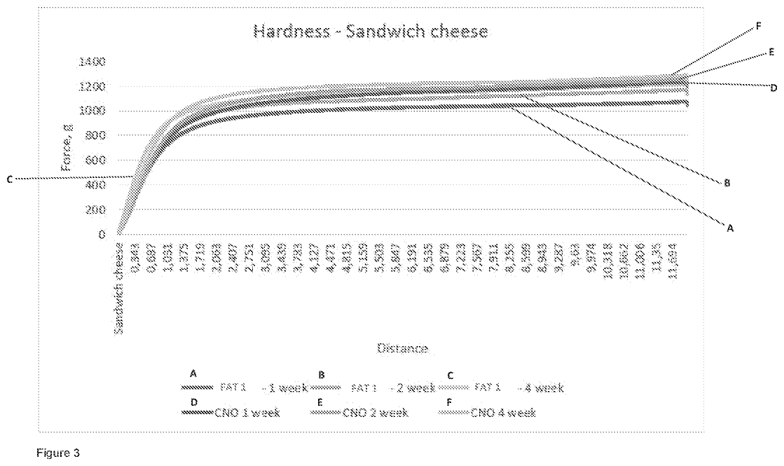

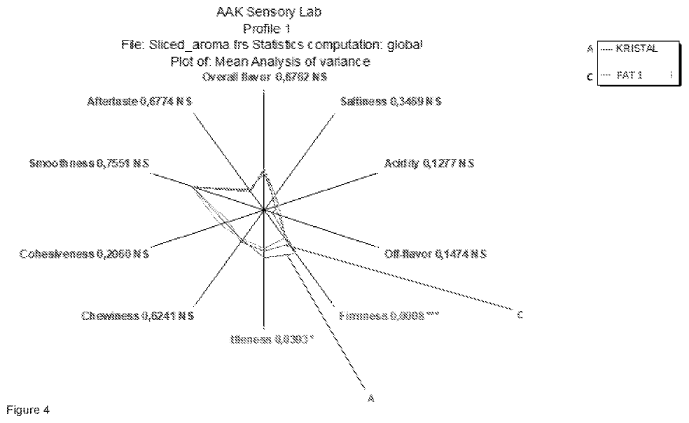

A slice of the sandwich cheese was tested in the same way as described above for the pizza cheese in Example 1. The results of the hardness test and the sensory evaluation are shown in FIGS. 3 and 4 respectively. Also shown are the results for a comparative cheese analogue composition containing the same amount by weight of all components of the composition of the invention, with the exception that it comprised 25% by weight coconut oil instead of 25% by weight of the interesterified fat blend composition. It can be seen from FIG. 3 that same trends as described above for the pizza cheese in FIG. 1 are observed. In FIG. 3, the cheese analogue of the invention is depicted as Fat 1, and the comparative cheese analogue is depicted as CNO.

FIG. 4 shows the results of a sensory evaluation done on a cheese analogue according to the invention (shown as Fat 1); and KRISTAL (the comparative cheese analogue comprising coconut oil). It can be seen that the coconut oil cheese KRISTAL has a higher firmness and brittleness than the cheese analogue of the invention. Such characteristics are less desirable for the reasons discussed above. Too much firmness and brittleness also make the cheese resemble conventional dairy cheeses less closely. The sensory properties of the sandwich cheese of example 2 are thus better than the comparative cheese comprising coconut oil.

### EXAMPLE 3

A feta cheese analogue composition according to the invention was manufactured. The cheese analogue composition comprised 56.89% by weight water; 24.95% by weight of an interesterified fat blend; 11.98% by weight of a starch blend; 3.99% by weight of a starch/non-animal protein blend; 2% by weight of salt; and 0.2% by weight of citric acid. The interesterified fat blend was the same as that used above in Examples 1 and 2.

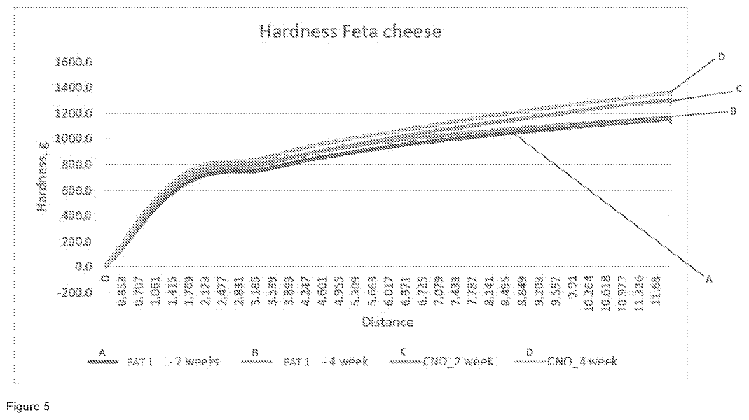

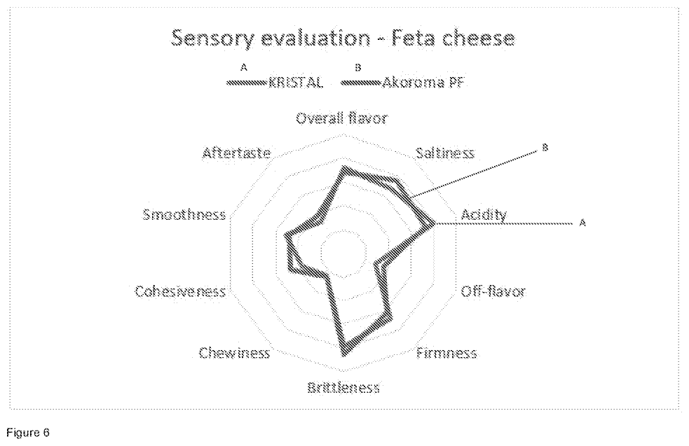

The feta cheese was tested in the same way as described above for the cheeses in Examples 1 and 2. The results of the hardness test and the sensory evaluation are shown in FIGS. 5 and 6 respectively. Also shown are the results for a comparative cheese analogue composition containing the same amount by weight of all components of the composition of the invention, with the exception that it comprised 24.95% by weight coconut oil instead of 24.95% by weight of the interesterified fat blend composition.

It can be seen from FIG. 5 that same trends as described above for the pizza cheese in FIG. 1 are observed. In FIG. 5, the cheese analogue of the invention is depicted as Fat 1, and the comparative cheese analogue is depicted as CNO.

FIG. 6 shows that the feta cheese analogue of the invention had a similar score to the feta cheese containing coconut oil in the sensory evaluation. The cheese Akoroma RF was the cheese according to the invention. The cheese KRISTAL was the comparative cheese comprising coconut oil.

1. A cheese analogue composition comprising from 20% to 30% by weight of a fat composition; from 1% to 45% by weight of a starch; from 0% to 15% by weight of nonanimal protein; and from 35% to 65% by weight of water; wherein the combined weight percent of starch and non-animal protein in the composition does not exceed 45%; wherein the fat composition comprises from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition.

2. A cheese analogue composition according to claim 1, wherein the fat composition comprises from 20% to 70% by weight of saturated fatty acids.

3. A cheese analogue composition according to claim 1, wherein the fat composition comprises less than 10% by weight of palm oil, preferably, wherein the composition comprises lees than 5% by.

4. A cheese analogue composition according to claim 1, wherein the fat composition is a non-hydrogenated fat composition.

5. A cheese analogue composition according to claim 1, wherein the fat composition comprises 20% by weight or less, of palmitic acid (C16:0).

6. A cheese analogue composition according to claim 1, wherein the fat composition has a weight ratio of stearic acid (C18:0) to palmitic acid (C16:0) of from 1:1 to 12:1.

7. A cheese analogue composition according to claim 1, wherein the fat composition has a weight ratio of lauric acid (C12:0) to stearic acid (C18:0) of from 1:4 to 4:1.

8. A cheese analogue composition according to claim 1, wherein the fat composition comprises from 10% to 25% by weight lauric acid (C12:0); and/or from 15% to 45% by weight stearic acid (C18:0).

9. A cheese analogue composition according to claim 1, wherein the fat composition has a solid fat content (SFC) N35 of less than 5, measured on unstabilised fat according to ISO 8292-1.

10. A cheese analogue composition according to claim 1, wherein the fat composition comprises an interesterified fat.

11. A cheese analogue composition according to claim 10, wherein the interesterified fat has been produced by chemical interesterification, enzymatic interesterification, or a combination thereof.

12. A cheese analogue composition according to claim 10, wherein the interesterified fat is produced by an interesterification reaction that is stopped prior to reaching an equilibrium product distribution.

13. A cheese analogue composition according to claim 1, wherein the fat composition comprises an interesterified fat blend comprising at least one fat selected from shea butter, shea stearin, shea olein, cocoa butter, cocoa stearin, cocoa olein, allanblackia fat, kokum fat, mango kernel fat, sal fat, illipe butter, and mixtures thereof; and at least one oil selected from coconut oil, coconut oil stearin, coconut oil olein, palm kernel oil, palm kernel olein, palm kernel stearin, babassu oil, and mixtures thereof.

14. A cheese analogue composition according to claim 1, wherein the fat composition comprises an interesterified blend of shea butter and coconut oil or an interesterified blend of shea stearin and coconut oil.

15. A cheese analogue composition according to claim 1, wherein the fat composition comprises an interesterified blend of from 20% to 80% by weight of shea butter and from 20% to 80% by weight of coconut oil.

16. A cheese analogue composition according to, wherein the fat composition comprises an interesterified blend of from 20% to 80% by weight of shea stearin and from 20% to 80% by weight of coconut oil.

17. A cheese analogue composition according to claim 1, wherein the fat composition comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of liquid oil such as sunflower oil, rapeseed oil, or a combination thereof.

18. A cheese analogue composition according to claim 1, wherein the fat composition comprises from 5 to 35 percent by weight of CN46 and CN48 triglycerides.

19. A cheese analogue composition according to claim 1, wherein the fat composition comprises from 2 to 12 percent by weight of St2M triglycerides.

20. A cheese analogue composition according to claim 1, wherein the starch comprises non-modified starch, modified starch, or a combination thereof.

21. A cheese analogue composition according to claim 1, wherein the starch comprises a non-modified or modified vegetable starch, rice starch, tapioca starch or a combination thereof.

22. A cheese analogue composition according to claim 1, wherein the non-animal protein comprises plant protein.

23. A cheese analogue composition according to claim 1, wherein the cheese analogue composition further comprises an animal milk-derived protein.

24. (canceled)

25. (canceled)

26. (canceled)

27. (canceled)

28. (canceled)

29. (canceled)

30. (canceled)

31. A cheese analogue composition according to claim 1, wherein the cheese analogue composition comprises from 35% to 55% by weight of water; and wherein the combined weight percent of starch and non-animal protein in the cheese analogue composition is from 25% to 35%.

32. A cheese analogue composition according to claim 1, wherein the cheese analogue composition comprises from 45% to 55% by weight of water; and wherein the combined weight percent of starch and non-animal protein in the cheese analogue composition is from 20% to 35%.

33. A cheese analogue composition according to claim 1, wherein the cheese analogue composition comprises from 50% to 65% by weight of water; and wherein the combined weight percent of starch and non-animal protein in the cheese analogue composition is from 5% to 25%.

34. A cheese analogue composition according to claim 1, wherein the fat composition has a solid fat content (SFC) N10 of less than 60, measured on unstabilised fat according to ISO 8292-1.

35. A cheese analogue composition according to claim 1, wherein the combined weight percent of starch and non-animal protein in the cheese analogue composition is less than 30%.

36. A food product comprising a cheese analogue composition according to claim 1.

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. A process of manufacturing a cheese analogue composition according to claim 1, wherein the process comprises combining a fat composition, water, starch, and optionally non-animal protein and/or one or more additional components to form the cheese analogue composition, and optionally forming the cheese analogue composition into food products.

52. (canceled)
